(19) United States
(12) Patent Application Publication
(10) Pub. No.: US 2011/0277506 A1
(43) Pub. Date: Nov. 17, 2011

(54) METHOD AND APPARATUS FOR HEATING GLASS SHEETS

(75) Inventors: Troy R. Lewandowski, Maumee, OH (US); James P. Schnabel, JR., Holland, OH (US)

(73) Assignee: GLASSTECH, INC., Perrysburg, OH (US)

(21) Appl. No.: 12/780,285

(22) Filed: May 14, 2010

(51) Int. Cl. C03B 27/00; C03B 23/00

(52) U.S. Cl. 65/90; 65/273

(57) ABSTRACT

A method for heating glass sheets includes alternately loading on a conveyor system two different sets of glass sheets with the glass sheets of each set having different properties than those of the other set so as to require different heating than each other; conveying the alternately loaded sets of glass sheets on the conveyor system along a plane of conveyance through a heating chamber having a heating system; and controlling operation of the heating system to provide two different sets of heating zones alternating along the direction of conveyance and respectively moving with the two sets of glass sheets so as to provide heating in the heating chamber of each set of glass sheets as required and in a different way than the heating of the other set of glass sheets.

### TECHNICAL FIELD

The disclosure relates to methods and apparatuses for heating glass sheets.

### BACKGROUND

Glass sheets may be heated for processing such as forming, quenching for heat strengthening or tempering, or forming followed by quenching or annealing. Examples of methods and apparatuses for heating glass sheets are disclosed in U.S. Pat. No. 6,783,358.

### SUMMARY

According to an embodiment of the present disclosure, a method for heating glass sheets comprises alternately loading on a conveyor system two different sets of glass sheets with the glass sheets of each set having different properties than those of the other set so as to require different heating than each other; conveying the alternately loaded sets of glass sheets on the conveyor system along a plane of conveyance through a heating chamber having a heating system; and controlling operation of the heating system to provide two different sets of heating zones alternating along the direction of conveyance and respectively moving with the two sets of glass sheets so as to provide heating in the heating chamber of each set of glass sheets as required and in a different way than the heating of the other set of glass sheets.

A furnace for heating glass sheets according to an embodiment of the present disclosure comprises a housing defining a heating chamber, and a conveyor system associated with the housing for alternately receiving two different sets of glass sheets, with the glass sheets of each set having different properties than those of the other set so as to require different heating. The conveyor system provides conveyance of the alternate sets of glass sheets through the heating chamber along a plane of conveyance. The furnace further includes a heating system associated with the housing. In addition, the furnace includes a programmable controller for operating the heating system to provide two different sets of heating zones alternating along the direction of conveyance and respectively moving with the alternate sets of glass sheets to provide heating of at least one set of glass sheets as required and in a different way than any operation thereof for the glass sheets of the other set.

While exemplary embodiments are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a side elevational view of one embodiment of a glass processing system including a furnace constructed in accordance with the present disclosure;

FIG. 2 is a cross sectional view taken through the furnace along line 2-2 in FIG. 1 and viewed in the direction of the arrows;

FIG. 3 is a perspective and partially schematic view of a hot air distribution system that provides forced convective heating of a glass sheet conveyed on a conveyor system of the furnace;

FIG. 4a is a partial view taken in the same direction as FIG. 1 to illustrate the manner in which uncoated glass sheets are conveyed on the conveyor system for the heating;

FIG. 4b is a partial view taken in the same direction as FIG. 1 to illustrate the manner in which coated glass sheets are conveyed on the conveyor system with a coated surface thereof facing upwardly and an uncoated surface thereof facing downwardly and supported by rolls of the conveyor system for the heating;

FIG. 5 is an enlarged partial perspective view of the hot air distribution system showing hot air distributors that may be utilized to provide the forced convective heating;

FIG. 6 is a partial sectional view taken along line 6-6 in FIG. 5 and viewed in the direction of the arrows to illustrate the manner in which the forced convection heating may be performed;

FIG. 7 is a bottom plan view taken along line 7-7 in FIG. 6 and viewed in the direction of the arrows, wherein this view illustrates the manner in which an array of the hot air distributors have staggered delivery orifices for delivering downwardly directed convective heating;

FIG. 8 is an elevational view illustrating another construction of hot air distributors of the hot air distribution system;

FIG. 9 is an elevational view of the hot air distributors taken along line 9-9 in FIG. 8 and viewed in the direction of the arrows; and

FIG. 10 is a schematic view showing another embodiment of a control system for controlling operation of the hot air distribution system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention. Furthermore, as those of ordinary skill in the art will understand, various features of the embodiments illustrated and described with reference to any one of the Figures may be combined with features illustrated in one or more other Figures to produce embodiments that are not explicitly illustrated or described. In addition, other embodiments may be practiced without several of the specific features explained in the following description.

During manufacture of a glass sheet product, such as a vehicle windshield, rear window, or any other suitable product, it may be desirable to heat sheets of glass so that they may be further processed. For example, it may be desirable to heat sheets of glass prior to performing a forming operation or any other suitable procedure. In the present disclosure, methods and apparatuses are provided for heating consecutive glass sheets having different properties so that they may be further processed.

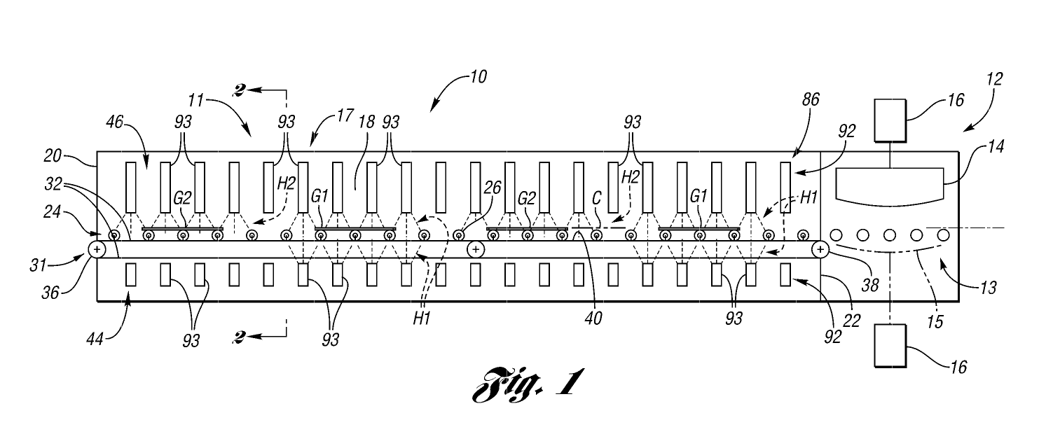

Referring to FIG. 1, a glass sheet processing system 10 is provided with a heating apparatus or furnace 11 constructed in accordance with the present disclosure to heat two or more different sets of glass sheets having different properties. For example, the furnace 11 may be used to heat first and second sets G1 and G2, respectively, of glass sheets that have different compositions, different thicknesses, different surface characteristics (e.g., coated and uncoated surfaces), or any combinations thereof. The glass sheets of each particular set G1, G2, however, generally have the same properties.

The system 10 also includes a processing station 12 for processing the heated glass sheets, such as glass sheets G1 and G2. For example, the processing station 12 may be constructed to perform a forming operation, such as a bending operation, a quenching operation for heat strengthening or tempering, or any combination of the above operations or other operations. As a more detailed example, the processing station 12 may be configured as a forming station having a wheel bed 13 for receiving a heated glass sheet G1, G2, a movable first mold such as an upper press mold 14, a movable second mold such as a lower peripheral press ring 15, and one or more actuators 16 that provide relative vertical movement between the wheel bed 13 and the press ring 15 and between the press ring 15 and the press mold 14 to move the heated glass sheet above the wheel bed 13 and into pressing engagement between the press ring 15 and a curved surface of the press mold 14 to press bend the glass sheet. The press mold 14 and press ring 15 may also be provided with a relatively soft surface treatment, such as cloth, to reduce or prevent damage to the glass sheets during bending operations. Additional details of an example forming station are disclosed in U.S. Pat. No. 6,543,255, which is hereby incorporated in its entirety by reference.

A method for heating glass sheets G1 and G2 in accordance with the present disclosure may be performed within the furnace 11 to heat glass sheets G1 and G2 from an ambient temperature to a sufficiently high temperature for the processing to be performed. Both the furnace 11 and the glass sheet heating method will be described in an integrated manner to facilitate an understanding of all aspects of the invention.

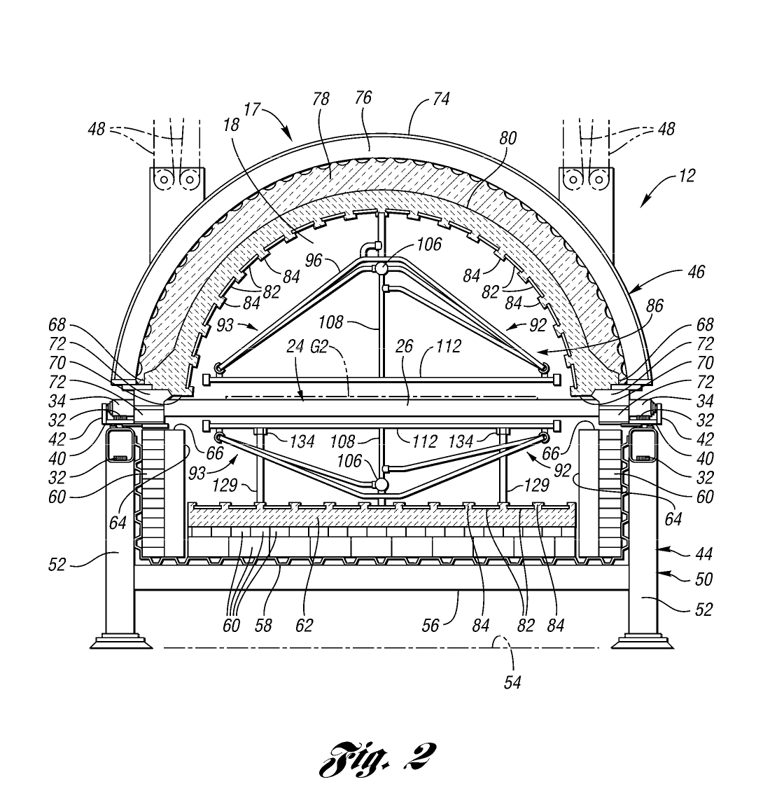

Furnace 11 as illustrated in FIGS. 1 and 2 includes an insulated housing 17 that defines a heating chamber 18 in which the glass sheets G1 and G2 are heated. This housing 17 as shown in FIG. 1 may have a somewhat elongated construction including a left entrance end 20 where the glass sheets are introduced for the heating and a right exit end 22 where the heated glass sheets are delivered to the processing station 12. Because many types of the processing performed within the station 12 may be at a hot temperature, the processing system 10 may be configured as an essentially continuous heated chamber between the furnace 11 and the processing station 12.

Within the heating chamber 18, the furnace 11 includes a conveyor system, such as a roll conveyor 24 having rolls 26, for conveying the glass sheets to be heated along a horizontal conveying plane C between the entrance and exit ends 20 and 22, respectively. While the rolls 26 may be made of any suitable material, in one embodiment, the rolls 26 are made of sinter bonded fused silica particles so as to be resistant to thermal warpage. Furthermore, roll conveyor 24 illustrated in FIGS. 1 and 2 may be of the type disclosed by U.S. Pat. Nos. 3,806,312; 3,934,970 and 3,994,711, for example, wherein a rotary drive 31 of the conveyor includes a pair of continuous drive loops 32 that respectively support and frictionally drive opposite ends 34 of the conveyor rolls 26. Drive loops 32 may be embodied as chains of the link type connected by pins, and may be received by associated toothed wheels 36 and 38 adjacent the entrance and exit ends 20 and 22 of the furnace housing at each of its lateral sides. Driving of these toothed wheels 36 and 38 slidably moves an upper reach of each drive loop 32 over an associated support surface 40 located outside of the furnace housing heating chamber 18 at the adjacent lateral side of the furnace. Roll positioners 42 project upwardly from the support surfaces 40 and capture central pins of the roll ends such that movement of the drive loops 32 frictionally drives the roll ends to provide rotation of the rolls 26 and consequent conveyance of the glass sheets G1 and G2 supported by the rolls 26 within the heating chamber 18. With such a configuration, the rotary drive 31 may drive the conveyor rolls 26 in a first direction or in opposite directions so as to move the glass sheets G1 and G2 continuously from the entrance end 20 of the furnace housing 17 to the exit end 22, or in an oscillating manner between the entrance and exit ends 20 and 22.

As another example, the roll conveyor 24 may include toothed belts that drive toothed sprockets on the rolls. Alternatively, the furnace 11 may include a conveyor system having any suitable construction for conveying the glass sheets G1 and G2.

The furnace housing 17 illustrated in FIG. 2 includes a fixed lower housing portion 44 and a vertically movable upper housing 46 supported by counterbalanced chains 48 so as to permit access to the interior of the furnace 11 by upward movement. A framework 50 of the lower housing portion 44 has legs 52 supported on a support surface, such as a factory floor 54, and horizontal beams 56 that support a corrugated metal liner 58. The liner 58 supports ceramic blocks 60 which support an insulated floor 62 and insulated vertical side walls 64 having upper ends 66.

The upper housing portion 46 has a downwardly opening semicircular shape having lower ends 68 that cooperate with the upper ends 66 of the lower housing side walls 64 to define side slots 70 through which the conveyor roll ends 34 project outwardly from the heating chamber 18. Heat seals 72 seal in the side slots 70 between the lower housing vertical wall upper ends 66, the upper housing lower ends 68 and the roll ends 34 to reduce heat loss from the furnace 11. The drive loops 32 and toothed wheels 36 and 38 may thus provide rotary driving of the conveyor roll ends 34 externally of the heating chamber 18. Also, the upper housing portion 46 has an outer semicircular metal skin 74 supported on a generally semicircular metal frame 76, and outer and inner semicircular ceramic blocks 78 and 80 located within the frame 76.

With continuing reference to FIG. 2, the furnace 11 may also include a radiant heating system comprising one or more radiant heaters, such as electric resistance elements 82, located within the heating chamber 18 below and/or above the roll conveyor 24 for heating interior furnace components, such as conveyor rolls 26, and/or air within the heating chamber 18. More specifically, the floor 62 of the lower housing portion 44 may include T-shaped retainers 84 for securing the electric resistance elements 82. Electric resistance elements 82 may also be mounted on the lower side walls 64. Furthermore, the inner downwardly opening semicircular ceramic block 80 of the upper housing portion 46 may have T-shaped retainers 84 that secure electric resistance elements 82 above the roll conveyor 24.

With the furnace construction defined above, much of the radiant heating of the lower surfaces of the glass sheets G1 and G2 may be provided by radiation from lower electrical resistance elements 82 and the hot conveyor rolls 26. In addition, heating may also be provided by conduction from the conveyor rolls 26, as well as natural convection. Furthermore, the semicircular construction of the upper housing portion 46 provides a more uniform radiant heating of the upper surface of the conveyed glass sheets G1 and G2 than is possible with a downward opening housing portion having right angle corners.

In another embodiment, the radiant heating system may be configured as a burner system including one or more burners that provide radiant heating. The burners may be supplied a flammable fuel, such as propane or butane, that is burned to generate radiant heat.

In yet another embodiment, the furnace 11 may be provided without a radiant heating system. In such an embodiment, the interior of the furnace 11 may be heated by any suitable heating system. For example, the furnace 11 may be connected via ductwork to a remote heating system that periodically supplies hot air to the furnace 11 to maintain the heating chamber 18 at a desired temperature.

The furnace 11 also includes a heating system that provides different heating zones or waves, as explained below in detail. In the embodiment illustrated schematically in FIG. 1 and further illustrated in FIGS. 2 and 3, that heating system is a convective heating system, such as a hot gas or hot air distribution system 86, which is located within the furnace heating chamber 18 between the entrance and exit ends 20 and 22 above and/or below the roll conveyor 24. The system 86 may supply hot gas jets, such as hot air jets 88 (FIG. 6), upwardly and/or downwardly toward the conveyed glass sheets G1 and/or G2 to entrain hot air within the heating chamber 18, and the combined flow of hot air may provide convective heating of the glass sheets in addition to the heating thereof by the electric resistance elements 82 or other heating system. The hot air jets 88 may entrain a large amount of heated air within the furnace 11, perhaps 5 to 20 times the mass flow of the jets, such that substantial forced convection heating results.

A control system or control collectively indicated by 89 in FIG. 3 controls the hot air distribution system 86 during glass sheet conveyance so that the glass sheets G1 and G2 may be heated to the same general temperature. For example, the control 89 may control operation of the hot air distribution system 86 to provide, as shown in FIG. 1, first and second sets H1 and H2 of heating waves or zones that alternate along the direction of conveyance and respectively move with the first and second sets G1 and G2, respectively, of glass sheets so as to provide convective heating of at least one of the sets G1 or G2 of glass sheets as required and in a different way than operation thereof for the glass sheets of the other set G1 or G2.

With such a configuration, each heating zone H1, H2 may be adapted for a particular glass sheet G1, G2 and may be applied such that the heating zone H1, H2 follows the particular glass sheet G1, G2 through the furnace 11. As a result, consecutive glass sheets having different properties and different heating characteristics may be heated to generally the same temperature, or to different temperatures, by the furnace 11. For example, if each glass sheet of the first set G1 has a thickness that is greater than the thickness of each glass sheet of the second set G2, the hot air distribution system 86 may be operated to provide first heating zones H1 that each provide a greater amount of convective heating than the second heating zones H2. As another example, if the glass sheets of the first set G1 have a composition characterized by a low iron content compared to the composition of the glass sheets of the second set G2, which may result in the glass sheets of the first set G1 being more difficult to heat, then the hot air distribution system 86 may again be operated to provide first heating zones H1 that provide a greater amount of convective heating than the second heating zones H2. As yet another example, if the glass sheets of the second set G2 are each provided with a coating, such as a low emissivity coating, on one side, then the hot air distribution system 86 may be operated to provide corresponding heating zones H2 that provide a greater amount of convective heating on the side of the glass sheets having the coating as compared to the other heating zones H1. Examples of suitable coatings include metallic coatings, such as heat reflective coatings or metallic conductive coatings.

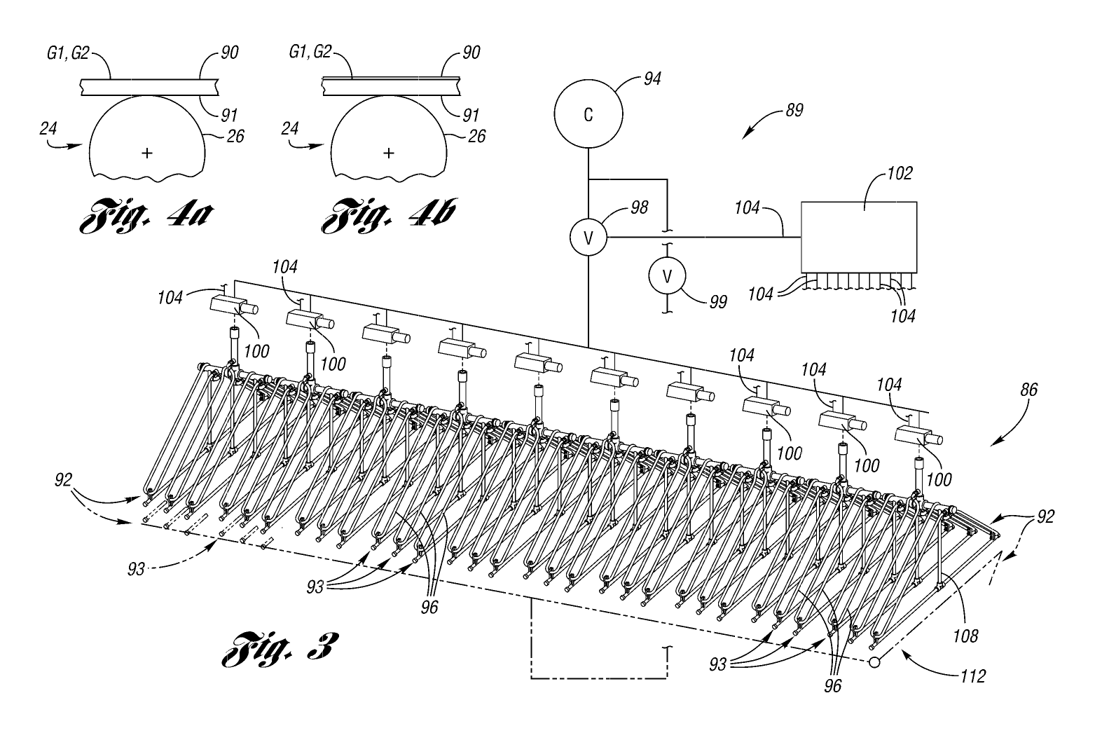

When the heating is performed on an uncoated glass sheet G1 or G2 as illustrated in FIG. 4a, the amount of upward and downward convective heating may be controlled so that this convective heating as well as the radiant heating provided by the electric resistance elements 82 maintain the upper and lower surfaces 90 and 91 of the particular glass sheet at the same temperature as each other throughout the heating. With both the radiant heating and this forced convection heating in the manner described, efficient heating of the particular glass sheet can be achieved.

When a glass sheet G1 or G2 having a coating on an upper side, for example, is heated as illustrated in FIG. 4b, the coating may reflect much of the radiant energy such that a greater amount of downward forced convection heating may be necessary to balance the radiant, conduction and natural convection heating of the lower surface. Thus, an increase of the convective heating of the upper coated surface 90 provides the balancing required so that both surfaces may be heated at the same rate and have the same temperature so the glass remains planar during its heating. This increase in the convective heating may be provided at an increasing rate over time and may be controlled by the total mass flow of pressurized air supplied through the hot air distribution system 86 to provide the hot air jets that also entrain the hot air within the furnace heating chamber 18.

While the hot air distribution system 86 may have any suitable configuration, in the embodiment illustrated in FIGS. 1 through 3, the hot air distribution system 86 includes lower and upper arrays 92 of hot air distributors 93 positioned below and above the roll conveyor 24 between the entrance and exit ends 20 and 22 of the furnace 11. A source 94 of pressurized gas or air shown in FIG. 3, such as a compressor, may be located outside the furnace 11 to supply pressurized air to the hot air distributors 93. The source 94 may supply air at any suitable pressure, such as 20 to 25 pounds per square inch (psi). Furthermore, the hot air distributors 93 include heat exchangers 96 for heating the pressurized air prior to delivery therefrom as the hot air jets 88 shown in FIG. 6. With these heat exchangers 96 as are hereinafter more fully described, the hot air jets 88 may be supplied at a temperature only slightly less than the furnace ambient air temperature. For example, if the air in the furnace heating chamber is about 700° C., the hot air jets may be only about 20 to 40° C. lower, i.e., about 660 to 680° C.

As shown in FIG. 3, the control 89 may include valves 98 and 99 through which pressurized air is respectively supplied from the source 94 to the upper and lower arrays 92 of hot air distributors 93, as well as pressure controllers such as electric pressure regulators 100 for both the upper and lower arrays 92 that each control the air flow to one or more hot air distributors 93. More specifically, as illustrated, each pressure regulator 100 for the upper array 92 may control the flow of pressurized air from the control valve 98 to one or more, such as three, of the hot air distributors 93. Although not shown, the pressure regulators for the lower array 92 may likewise control the flow of pressurized air from the control valve 99 to one or more, such as three, of the associated hot air distributors 93. An example of a suitable pressure regulator is an electro-pneumatic regulator available from SMC Corporation of America, which is located in Noblesville, Ind.

Control 89 may further include a programmable controller 102 for controlling operation of the valves 98, 99 and/or pressure regulators 100 to control the air pressure supplied to the hot air distributors 93 of the upper and lower arrays 92, and thereby provide the pressure that supplies the necessary mass flow to achieve the desired convective heating to be performed from above and/or below the roll conveyor 24. For example, controller 102 may command a particular pressure versus time profile for each pressure regulator 100, such that the pressure regulators may provide any suitable air pressure, such as 0 to 20 psi, to the hot air distributors 93. Furthermore, the controller 102 may communicate with the valves 98, 99 and pressure regulators 100 wirelessly or through connections 104, such as wire connections.

The controller 102 may be coupled with the conveyor 24 and suitable sensors, such as glass detection sensors, so that the controller 102 may control the hot air distribution system 86 to provide hot air jets only where there is an adjacent glass sheet G1, G2 being conveyed, and so that a corresponding heating wave or zone H1, H2 may follow the glass sheet G1, G2. Thus, after the glass sheet G1, G2 passes each set of hot air distributors 93, the associated pressure regulator 100 may terminate the flow of hot air so as to provide efficiency in the convective heating supplied by the hot air distribution system 86.

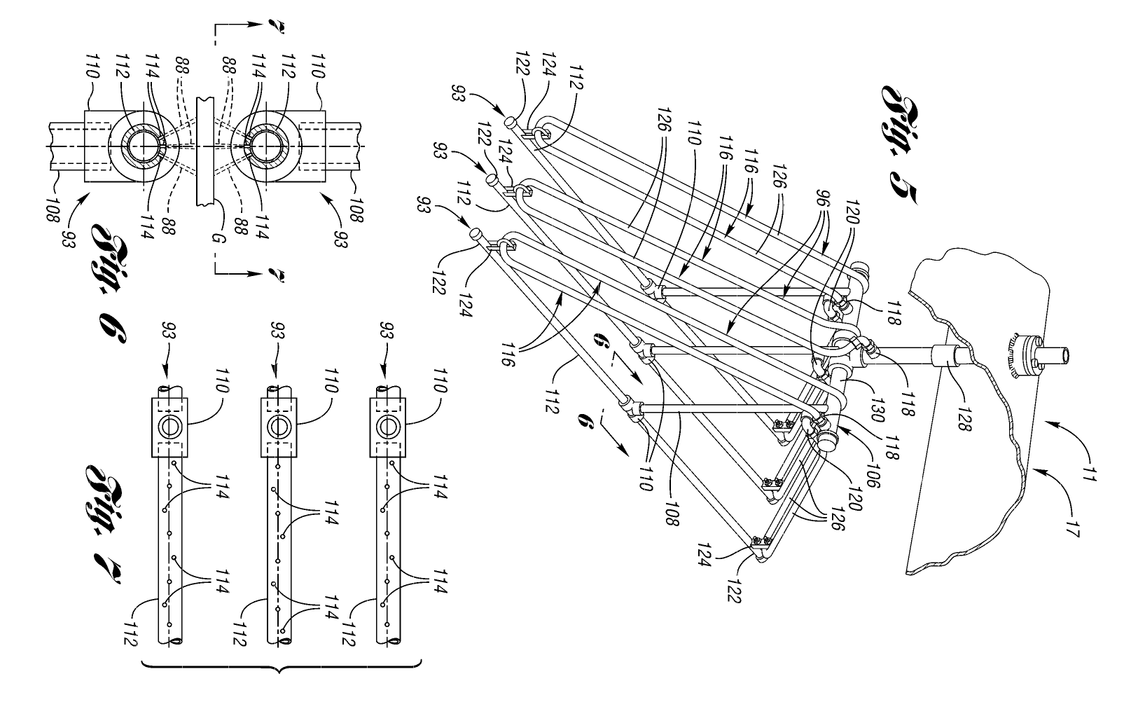

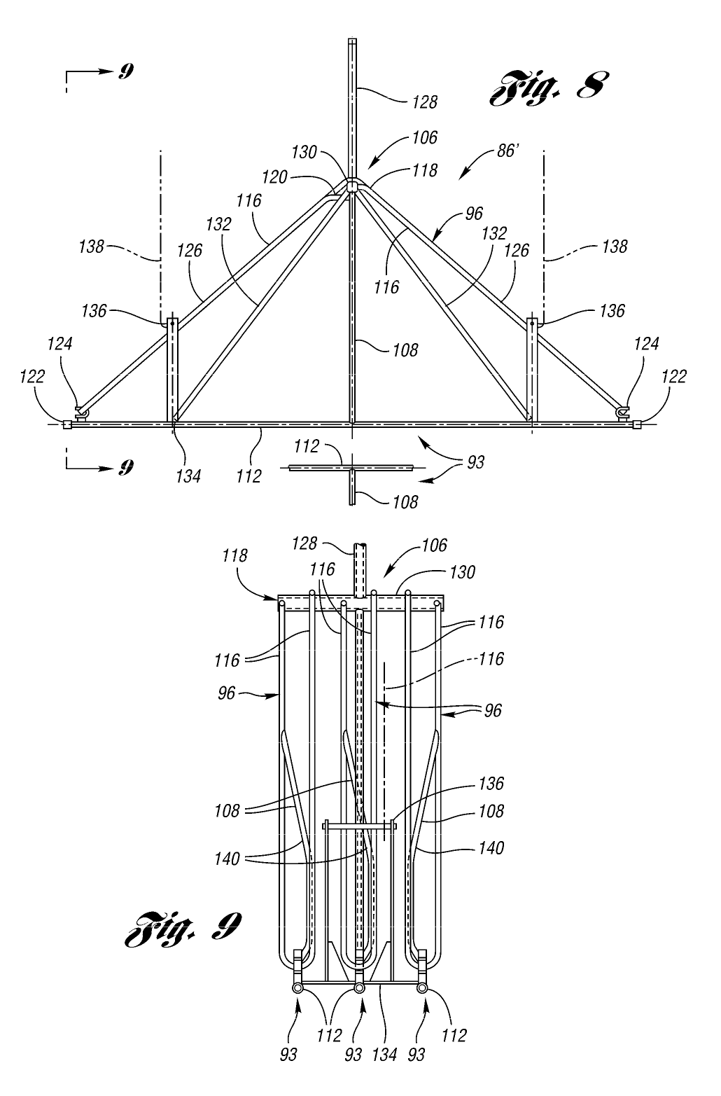

With reference to FIG. 5, the illustrated hot air distributors 93 of the upper array 92 are also illustrative of the hot air distributors of the lower array except for their opposite vertical orientation and other features hereinafter described. As shown, each hot air distributor 93 may include a manifold 106 and a vertical support tube 108 having a first end that is supported by the manifold 106, such that the first end is not in direct fluid communication with the manifold 106. The vertical support tube 108 also has a second end adjacent the conveyor, and the second end is received by a T fitting 110. A horizontal delivery tube 112 of each hot air distributor 93 extends in opposite directions from the second end of the support tube 108 and is in fluid communication therewith through the T fitting 110. The delivery tubes 112 of the upper and lower hot air distributors 93 as shown in FIG. 6 have downwardly and upwardly directed orifices 114, which may function as aspirators. The delivery orifices 114 are provided in sets that are vertical and inclined in opposite directions from the vertical by an angle of about 30°. As illustrated in FIG. 7, the delivery orifices 114 of adjacent hot air distributors in both the lower and upper arrays are staggered laterally with respect to the direction of conveyance so as to prevent strip heating of the glass sheets.

As best illustrated in FIG. 5, the heat exchanger 96 of each hot air distributor 93 includes a heat exchanger tube 116 having an inlet 118 that is fed pressurized air through the manifold 106, and an outlet 120 through which pressurized air heated within the heat exchanger tube 116 is fed to the vertical support tube 108 for flow to the horizontal delivery tube 112. Pressurized air is fed from the horizontal delivery tube 112 through the orifices 114 thereof to provide the downwardly and/or upwardly directed hot air jets that entrain hot air in the heating chamber 18, such that the combined flow of hot air may provide convective heating of the upwardly and/or downwardly facing glass surfaces of each conveyed glass sheet as previously described. Each horizontal delivery tube 112 has opposite lateral ends 122 having a heat exchanger support 124. Each heat exchanger tube 116 has inclined portions 126 extending between the manifold 106 and the supports 124 at the pair of opposite lateral ends 122 of the delivery tube 112. More specifically, each heat exchanger tube 116 includes a pair of the inclined portions 126 that extend with an inverted V shape between the upper manifold 106 and the supports 124 at the opposite lateral ends 122 of the horizontal delivery tube 112. The supports 124 for the heat exchanger tube 116 permit movement between the heat exchanger tube 116 and the delivery tube 112 to account for differential heating that takes place between the heat exchanger tube 116 and the deliver tube 112 during operation.

The upper manifold 106 as shown in FIG. 5 includes a vertical supply tube 128 that extends vertically from the furnace housing 17, and the manifold 106 also has a horizontal supply tube 130 that extends horizontally from the vertical supply tube 128. Each manifold 106 supports three of the hot air distributors 93 as illustrated with the heat exchanger tube inlets 118 provided at the horizontal supply tube 130 for the two end distributors 93, and with the heat exchanger inlet 118 provided by the vertical supply tube 128 for the intermediate distributor 93. As another example, each manifold 106 may support any suitable number of the hot air distributors 93.

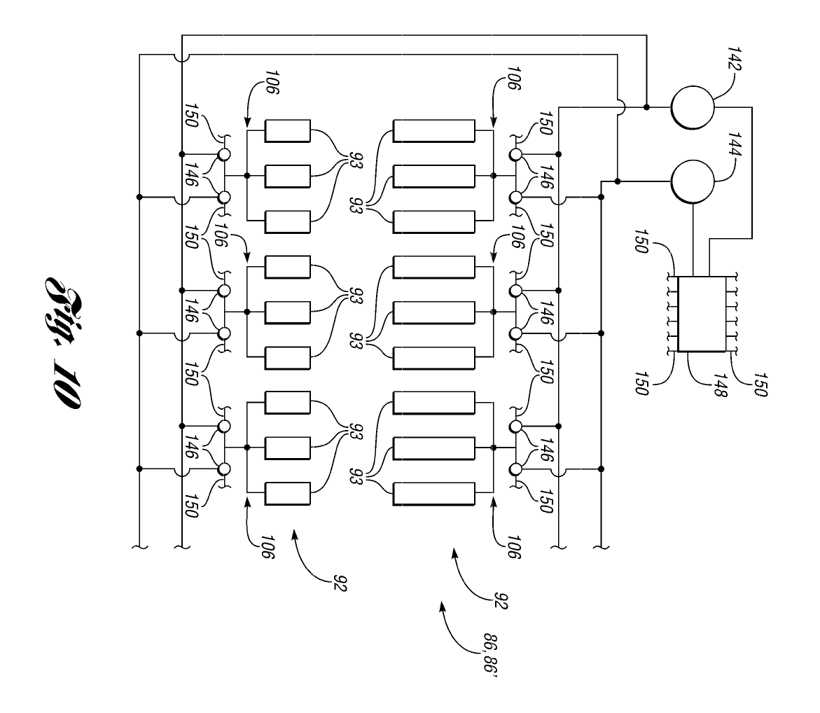

With reference to FIGS. 8 and 9, another embodiment 86′ of the hot air distribution system is shown. The system 86′ has the same construction as the previously described embodiment except as will be noted, such that like components thereof are identified by like reference numerals and much of the previous description is applicable and thus will not be repeated. In this embodiment of the hot air distribution system 86′, each hot air distributor 93 has fluid connections between the vertical support tube 108 and the horizontal delivery tube 112, between the heat exchanger tube 116 and the horizontal supply tube 130 and between the vertical supply tube 128 and the horizontal supply tube 130 provided by machined holes into which tube ends are inserted and then welded air tight so as to eliminate the need for fittings. Also, each upper hot air distributor 93 includes a pair of inclined supports 132 arranged in a V shape and having upper ends connected to the manifold 106 and lower ends connected to the horizontal delivery tube 112 to provide support to the delivery tube 112. The inclined supports 132 are connected to the horizontal delivery tube 112 inwardly from its ends 122 so as to define a smaller included angle than the angle defined by the inclined portions 126 of each heat exchanger tube 116.

The hot air distribution system 86′ illustrated in FIGS. 8 and 9 also includes support brackets 134 that connect adjacent upper hot air distributors 93 at the lower ends of their inclined supports 132. As illustrated, each bracket 134 connects three of the hot air distributors 93 which are supported by a common vertical supply tube 128 as a set. Each bracket 134 has an upper connector 136, and the furnace housing has downwardly extending roof supports 138 that support the upper connectors 136 of the brackets 134 which thereby cooperate in supporting the delivery tubes 112 of the associated hot air distributors 93. Each vertical support tube 108 as illustrated in FIG. 9 has a lower bent end 140 which provides space at a central location between the adjacent sets of three hot air distributors 93 for a location of thermocouples utilized for temperature sensing. To facilitate manufacturing, the central hot air distributor 93 of each set of three has its vertical support tube 108 also provided with such a lower bent end 140. Furthermore, the heat exchanger tubes 116 of each hot air distributor are all of the same construction with the two left ones illustrated in FIG. 9 oriented the same as each other and with the right one rotated 180° about a vertical axis so that the lower ends 140 provide the thermocouple space between the adjacent sets of three distributors.

As illustrated in FIG. 2, the lower array 92 of hot air distributors 93 also has supports 129 that extend upwardly from the floor 62 of the lower housing portion to brackets 134 that support the horizontal delivery tubes 112 of adjacent lower hot air distributors. Due to the available height, the heat exchangers 96 of the lower hot air distributors 93 are shown as having a slightly greater included angle. Because of the rolls 26 of the roll conveyor 24, these lower hot air distributors 93 may be spaced so as to provide upwardly directed hot air jets between the conveyor rolls and, as such, the spacing may not be as uniform as with the upper array 92 of hot air distributors 93.

Referring to FIG. 10, another embodiment 89′ of the control for controlling operation of the hot air distribution system 86 or 86′ is shown. The control 89′ may be used in conjunction with multiple sources of pressurized gas, such as air, that are connected to the hot air distribution system 86′ or 86, and that each supply gas, such as air, at a different pressure than the other sources. In the embodiment shown in FIG. 10, for example, first and second sources 142 and 144, respectively, of differently pressurized air are each connected to the upper and lower arrays 92 of hot air distributors 93, and the sources 142 and 144 are operable to supply air at any suitable pressure to the hot air distributors 93. For example, the first source 142 may supply air at a pressure in the range of 8 to 12 psi, and the second source 144 may supply air at a pressure in the range of 14 to 18 psi. Furthermore, the two different sources 142 and 144 of pressurized air may be connected to the air distributors 93 in any suitable manner. For example, the sources 142 and 144 may be connected to each manifold 106 associated with one or more hot air distributors 93 using a T-fitting.

As shown in FIG. 10, the control 89′ includes suitable control devices 146, such as solenoid valves, disposed between the sources 142 and 144 and the upper and lower arrays 92 of hot air distributors 93, and each control device 146 controls air flow from a particular source 142, 144 to one or more, such as three, of the hot air distributors 93. The control 89′ further includes a programmable controller 148 in communication with the control devices 146 for controlling operation of the control devices 146 to selectively supply pressurized air from either source 142, 144 to one or more manifolds 106 at a particular time. Furthermore, the controller 148 may communicate with the control devices 146 wirelessly or through suitable connections 150, such as wire connections.

With reference to FIGS. 1-10, the method for heating the glass sheets G1 and G2 will now be described in more detail. First, the method may include alternately loading the two different sets G1 and G2 of glass sheets onto the conveyor 24 of the furnace 11 using any suitable loading device, such as a robot or other suitable loading mechanism. As noted above, the glass sheets of each set G1, G2 have different properties than those of the other set G1, G2 so as to require different heating than each other. For example, the sets G1 and G2 of glass sheets may have different compositions, different thicknesses, different surface characteristics (e.g., coated and uncoated surfaces, or different surface coatings), and combinations thereof.

The method next involves conveying the alternately loaded sets G1 and G2 of glass sheets on the conveyor 24 along the plane of conveyance C through the heating chamber 18 to expose the glass sheets to the radiant heating elements 82 and/or the hot air distribution system 86. Although the furnace 11 shown in FIG. 1 is configured to receive four glass sheets at one time, the furnace 11 may be configured to receive any suitable number of glass sheets.

The method further involves controlling operation of the distributors 93 to provide the two different sets H1 and H2 of heating waves or zones alternating along the direction of conveyance C and respectively moving with the two sets G1 and G2 of glass sheets so as to provide convective heating of at least one of the sets G1 or G2 of glass sheets as required and in a different way than operation thereof for the glass sheets of the other set G1 or G2. For example, the distributors 93 may be operated to provide convective heating of one set G1, G2 of the glass sheets without providing convective heating of the other set G1, G2 of glass sheets. Thus, one set H1 or H2 of heating waves or zones may be characterized by lack of any gas jets 88. As another example, the distributors 93 may be operated to provide convective heating of both sets G1 and G2 of glass sheets but with different flows of pressurized air for each set of glass sheets.

Furthermore, as noted above, the hot air distribution system 86 may be operated to provide convective heating from above and/or below the plane of conveyance C for one or both sets G1, G2 of glass sheets. In the embodiment shown in FIG. 1, convective heating is provided from above and below the plane of conveyance C for the first set G1 of glass sheets and from above for the second set G2 of glass sheets.

The distributors 93 may also be operated to provide moving waves that supply relatively constant convective heating for the glass sheets of a particular set G1, G2, or the distributors 93 may be operated to provide moving waves that supply convective heating that is varied along the direction of conveyance C for the glass sheets of a particular set G1, G2.

Under the method of the present disclosure, consecutive glass sheets G1 and G2 having different properties may be heated to generally the same temperature so that the consecutive glass sheets may be processed in a uniform manner. For example, consecutive glass sheets G1 and G2 may be bent one after the other in the processing station 12, such that each glass sheet G1 and G2 is formed with essentially the same shape.

As a more detailed example, glass windshields for motor vehicles may be efficiently and effectively produced using the method according to the present disclosure. More specifically, a first set G1 of glass sheets that each have a thickness in the range of 2 to 2.3 millimeters (mm) may be alternately loaded onto the conveyor 24 along with a second set G2 of glass sheets that each have a thickness in the range of 1.3 to 1.7 mm, such that each glass sheet G1 is immediately followed by a glass sheet G2. The hot air distribution system 86 may be operated to provide alternating heating zones H1 and H2 that move with the glass sheets G1 and G2, respectively, such that a heating zone H1 moves with each glass sheet G1 through the furnace 11, and a heating zone H2 moves with each glass sheet G2 through the furnace 11. The heating zones H1 may be configured to provide a greater amount of convective heating compared to the heating zones H2 so that each glass sheet G1 may be heated to the same general temperature as an adjacent glass sheet G2 when the glass sheets G1 and G2 reach the exit end 22 of the furnace 11. Consecutive glass sheets G1 and G2 may then be consecutively bent in the processing station 12 such that each pair of adjacent glass sheets G1 and G2 may be formed with essentially the same shape. Each pair of glass sheets G1 and G2 may then be laminated together at a separate processing station to form a windshield.

Because each pair of adjacent glass sheets G1 and G2 may be heated to the same general temperature, such as a temperature in the range of 610 to 650 degrees Celsius, and because the glass sheets G1 and G2 are consecutively bent in the processing station 12, adjacent glass sheets G1 and G2 may be bent in a consistent manner. For example, variations in mold characteristics, such as compression of the cloth coverings on the press mold 14 and pressing ring 15, that may occur over time may have negligible or minimal affect on the complementary shapes of the glass sheets G1 and G2 since they are heated and molded consecutively. As a result, each pair of adjacent glass sheets G1 and G2 may be joined together in a subsequent lamination process to form a high quality windshield, wherein the shape of the glass sheet G1 closely matches the shape of the glass sheet G2. In this example, each glass sheet G1 may form an outer layer of a respective windshield, and each glass sheet G2 may from an inner layer of a respective windshield.

If required for a particular application, the furnace 11 and corresponding heating zones H1 and H2 may be used to heat the glass sheets G1 and G2 to different temperatures. For example, if the glass sheets G1 each have a greater thickness than the glass sheets G2, it may be desirable to heat the glass sheets G1 to a slightly higher temperature, such as a temperature that is 2 to 4 degrees Celsius higher as compared to the glass sheets G2, in order to achieve desired molded shapes for the glass sheets in a subsequent bending operation.

While exemplary embodiments are described above, it is not intended that these embodiments describe all possible forms of the invention. Rather, the words used in the specification are words of description rather than limitation, and it is understood that various changes may be made without departing from the spirit and scope of the invention. For example, the heating system that provides the different heating zones or waves may be any suitable heating system, such as a radiant heating system having multiple radiant heaters that are controlled to provide two different sets of heating zones that respectively move with two different sets of glass sheets. As another example, the processing system 10 may be configured to provide three or more different sets of heating zones in order to heat and process three or more different sets of glass sheets having different properties. Additionally, the features of various implementing embodiments may be combined to form further embodiments of the invention.

What is claimed is:

1. A method for heating glass sheets comprising:
alternately loading on a conveyor system two different sets of glass sheets with the glass sheets of each set having different properties than those of the other set so as to require different heating than each other;
conveying the alternately loaded sets of glass sheets on the conveyor system along a plane of conveyance through a heating chamber having a heating system; and
controlling operation of the heating system to provide two different sets of heating zones alternating along the direction of conveyance and respectively moving with the two sets of glass sheets so as to provide heating in the heating chamber of each set of glass sheets as required and in a different way than the heating of the other set of glass sheets.

2. The method of claim 1 wherein the heating system comprises a gas distribution system capable of operation to provide multiple gas jets that are spaced along the direction of conveyance to perform convective heating.

3. The method of claim 2 wherein the heating chamber further has a radiant heating system for providing radiant heating.

4. The method of claim 2 wherein the gas distribution system is operated to provide convective heating of one set of the glass sheets without providing convective heating of the other set of glass sheets.

5. The method of claim 2 wherein the gas distribution system is operated to supply the convective heating from above the plane of conveyance.

6. The method of claim 2 wherein the gas distribution system is operated to supply the convective heating from below the plane of conveyance.

7. The method of claim 2 wherein the gas distribution system is operated to supply the convective heating from both above and below the plane of conveyance.

8. The method of claim 2 wherein the gas distribution system is operated to provide convective heating of both sets of glass sheets but with different flows of pressurized air for each set of glass sheets.

9. The method of claim 2 wherein the gas distribution system is operated so at least one of the moving zones supplies convective heating that is varied along the direction of conveyance.

10. The method of claim 2 wherein the gas distribution system includes multiple distributors having multiple spaced apart orifices for providing the multiple gas jets, and multiple pressure regulators associated with the distributors, and wherein controlling operation of the gas distribution system includes controlling each pressure regulator to provide a desired pressure versus time profile.

11. The method of claim 2 wherein the gas distribution system is connectable to multiple sources of differently pressurized gas, and the gas distribution system includes multiple distributors and multiple control devices associated with the distributors, and wherein controlling operation of the gas distribution system comprises controlling the control devices to selectively control gas flow from the multiple sources of differently pressurized gas to the distributors.

12. The method of claim 1 wherein the two sets of glass sheets have different properties selected from the group consisting of different compositions, different thicknesses, different surface characteristics, and combinations thereof.

13. The method of claim 1 further comprising alternately bending the two sets of heated glass sheets.

14. The method of claim 11 further comprising attaching consecutive glass sheets together after the bending to form windshields.

15. A method for heating glass sheets comprising:
alternately loading on a roll conveyor two different sets of glass sheets with the glass sheets of each set having different properties than those of the other set and with the different properties selected from the group consisting of different compositions, different thicknesses, different surface characteristics, and combinations thereof such that the glass sheets of each set require different heating than the glass sheets of the other set;
conveying the alternately loaded sets of glass sheets along a plane of conveyance through a heating chamber having radiant heaters for providing radiant heating and multiple distributors spaced along the direction of conveyance and capable of operation to provide gas jets that perform convective heating; and
controlling operation of the distributors to provide two different sets of waves alternating along the direction of conveyance and respectively moving with the two sets of glass sheets so as to provide convective heating of at least one of the sets of glass sheets as required and in a different way than any operation thereof for the glass sheets of the other set, and with the different ways of operation being selected from the group consisting of 1) providing convective heating of one of the sets of glass sheets without providing convective heating of the other set of glass sheets, and 2) providing convective heating of both sets of glass sheets with different flows of pressurized air for each set of glass sheets.

16. A furnace for heating glass sheets comprising:
a housing defining a heating chamber;
a conveyor system associated with the housing for alternately receiving two different sets of glass sheets, with the glass sheets of each set having different properties than those of the other set so as to require different heating, the conveyor system further providing conveyance of the alternate sets of glass sheets through the heating chamber along a plane of conveyance;
a heating system associated with the housing; and
a programmable controller for operating the heating system to provide two different sets of heating zones alternating along the direction of conveyance and respectively moving with the alternate sets of glass sheets to provide heating of at least one set of glass sheets as required and in a different way than any operation thereof for the glass sheets of the other set.

17. The furnace of claim 16 wherein the heating system comprises a gas distribution system capable of operation to provide multiple gas jets spaced along the direction of conveyance to perform convective heating

18. The furnace of claim 17 further comprising a radiant heating system associated with the housing for providing radiant heating.

19. The furnace of claim 17 wherein the gas distribution system includes distributors mounted within the housing above the plane of conveyance to provide downwardly directed pressurized air flow.

20. The furnace of claim 17 wherein the gas distribution system includes distributors mounted within the housing below the plane of conveyance to provide upwardly directed pressurized air flow.

21. The furnace of claim 17 wherein the gas distribution system includes distributors mounted within the housing above and below the plane of conveyance to provide downwardly, upwardly, or both downwardly and upwardly directed pressurized air flow.

22. The furnace of claim 17 wherein the gas distribution system includes multiple distributors having multiple spaced apart orifices for providing the multiple gas jets, and multiple pressure regulators associated with the distributors, and wherein the programmable controller is configured to control the pressure regulators such that each pressure regulator provides a desired pressure versus time profile.

23. The furnace of claim 17 wherein the gas distribution system is adapted to be connected to multiple sources of differently pressurized gas, and wherein the gas distribution system includes multiple distributors and multiple control devices associated with the distributors, and the programmable controller is configured to control the control devices to selectively control gas flow from the multiple sources of differently pressurized gas to the distributors.
